(19) United States
(12) Patent Application Publication
(10) Pub. No.: US 2013/0342033 A1
(43) Pub. Date: Dec. 26, 2013

(54) Electromagnetic Propulsion System- Energy Solution System

(71) Applicant: James Ollans ESSEX, Diamond Bar, CA (US)

(72) Inventor: James Ollans ESSEX, Diamond Bar, CA (US)

(21) Appl. No.: 13/644,295

(22) Filed: Oct. 4, 2012

Related U.S. Application Data
(60) Provisional application No. 61/690,124, filed on Jun. 20, 2012.

(51) Int. Cl. H02K 7/06; H02K 53/00

(52) U.S. Cl. 310/20; 74/DIG. 9

(57) ABSTRACT

An electromechanical propulsion system is disclosed. The propulsion system uses magnetic propulsion movers to turn a shaft that can generate electrical power or rotational motion to move a vehicle. The propulsion system is well suited for use on land, air, space, above water and underwater vehicles. The propulsion system includes a plurality of electromagnets impart linear motion on a rotator connected to a shaft to turn the shaft. Multiple electromagnet movers can be used on a single rotator to increase the generated torque on the shaft. The electromagnetic propulsion system does not require consumption of any external fossil based fuels for operation. The electromagnet movers are manufactured in a self-contained configuration where it is controllable from a remote location.

### CROSS-REFERENCE TO RELATED APPLICATION

This application claims the benefit of Provisional Application Ser. No. 61/690,124 filed Jun. 20, 2012 the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention relates to improvements in an electromechanical propulsion system. More particularly, the propulsion system that uses magnetic propulsion and magnetic bearings to move a vehicle. The propulsion system includes a plurality of electromagnets that repel each other with strong and weak magnets to move the propulsion motor in linear motion as described in the inventor's prior U.S. Pat. No. 7,936,097.

2. Description of Related Art Including Information Disclosed Under 37 CFR 1.97 and 1.98

The need for a better propulsion motor will be a benefit to most areas of our lives. Typical rotational motors require the conversion of rotational energy into linear motion using gears or a transmission. Linear motors do not require a transmission to change energy into linear motion. Typically these motors are called inertial or vibratory motors. A number of different linear electromechanical propulsion systems have been patented and exemplary examples of these patents are described herein.

U.S. Pat. No. 3,266,233 patented on Aug. 16, 1966 by A. W. Farrall discloses an Inertial Propulsion Device where the device consists of a rotational motor that turns a transmission to move an inertial mass in an oscillation motion. The reaction of the oscillation moves the device along the surface of the ground. While this system discloses a linear motion device the linear motion is caused by a rotational motor.

U.S. Pat. No. 3,889,543 patented on Jun. 17, 1975 by Oscar Mast discloses a propulsion system that uses the interaction of two magnets to alternately create linear motion. These magnets are arranged in a parallel orientation and operate independent from each other to provide the motion. In the pending application the electromagnets are arranged in a linear orientation where the electromagnets can work in harmony to provide a more linear motion in a single motor package.

U.S. Pat. No. 4,801,111 patented on Jan. 31, 1989 by Charles E. Rogers et al. discloses a System for Propulsion and Positioning of a Transitory Object. In this patent a coil generates a magnetic field to move a piston. The magnetic field is then collapsed and the piston is pulled with a spring into a metal plate. The impact of the piston on the medial plate causes motion of the vehicle. While this patent discloses imparting motion on a vehicle, the motion requires an impact and this for does not make the motion linear in nature.

U.S. Pat. No. 6,369,469 patented on Apr. 9, 2002 by Lawrence D. Murry discloses a Poly Phase Linear Alternator. The mechanism requires a motor with a number of electromagnetic coils that move to impart motion on a vehicle they are attached to. This patent requires motors to adjust the gap between the electromagnetic plates. While this invention uses electromagnetic force for the propulsion the amount of force is determined by moving the magnetic plated with a motor.

U.S. Pat. No. 7,936,097 issued May 3, 2011 to James O Essex discloses an electromagnetic propulsion system. The electromagnetic propulsion system only discloses the individual movers and does not disclose the construction of a vehicle or using the movers to create rotational motion.

What is needed is an electromagnetic propulsion system that creates rotational energy that can turn wheel, a motor, or other device that rotates a shaft. The proposed electromagnetic propulsion system provides this solution with drivers that create rotational energy that can produce power for motion or electricity through a generator.

### BRIEF SUMMARY OF THE INVENTION

It is an object of the electromagnetic propulsion system to provide motion to a vehicle. Propulsion motors that are placed around a rotational axis to make the axis turn. Multiple propulsion motors can also be used to impart changes in the direction of travel of a vehicle.

It is an object of the electromagnetic propulsion system to be applied to a vehicle at the proper angle, using a closed number of propulsion motors. For example one to four propulsion motors will cause the wheel to spin/turn when the wheel is on a shaft.

It is an object of the electromagnetic propulsion system to be completely independent of a power grid. The device will be able to function as a complete “stand alone” system and operate for an indefinite period of time with no connection of any kind to the existing electrical grid or any other power supply system. Ultimately the device may be hooked to the grid/output to feed off its own power production.

It is an object of the electromagnetic propulsion system to be self-starting and therefore able to start from its own power supply, such as but not limited to batteries.

It is an object of the electromagnetic propulsion system to have a self-charging means that enables the system to recharge its starting system from its own power while simultaneously running a load.

It is an object of the electromagnetic propulsion system to not consume any external fossil based fuels of any kind.

It is an object of the electromagnetic propulsion system to provide significant usable power from multiple electromechanical systems that can be applied to produce AC current that is sufficient to power and satisfy the vehicle as needed.

It is an object of the electromagnetic propulsion system to include unique circuitry, gearing and wiring, electric motor, alternator and other components that result in this new and unique system of generating AC electric power.

It is an object of the electromagnetic propulsion system to be commercially viable for public, businesses and industry use. The system can also be used on land craft, water craft, air craft, space craft and on land bodies away from earth as a source of energy.

Various objects, features, aspects, and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 shows an isometric view of a single mover of the electromagnetic propulsion system.

FIG. 2 shows a perspective view of a plurality of electromagnetic propulsion movers powering an AC electric generator.

FIG. 3 shows a rotator with a single electromagnetic propulsion mover.

FIG. 4 shows a rotator with two electromagnetic propulsion movers.

FIG. 5 shows a rotator with three electromagnetic propulsion movers.

FIG. 6 shows a rotator with four electromagnetic propulsion movers.

FIG. 7 shows a connection between an alternator and an electric motor.

FIG. 8 shows a cross sectional view of an electromagnetic propulsion mover.

### DETAILED DESCRIPTION

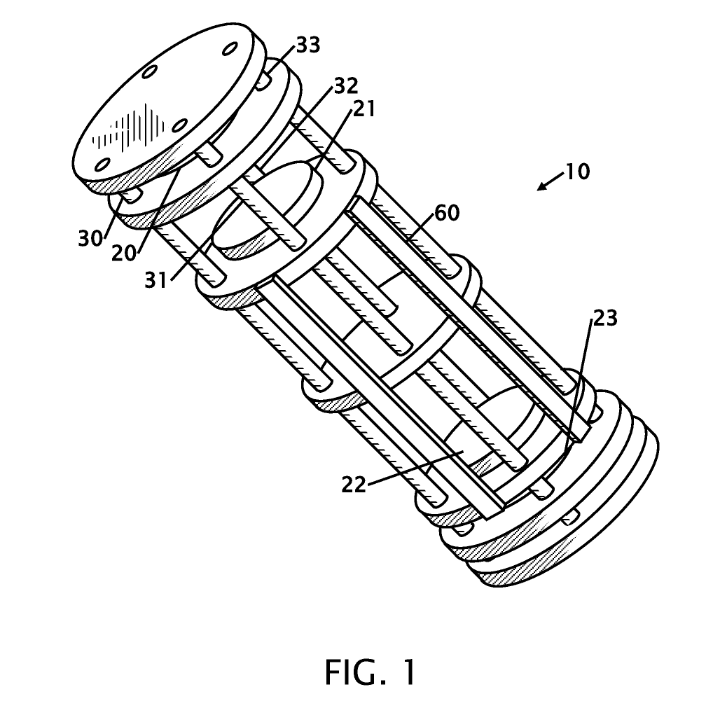

FIG. 1 shows an isometric view of the electromagnetic propulsion system with the power source and the receiver/controls removed. The electromagnetic propulsion system operates with pulse signals of on and off transmission where the “pulsating dc” creates motion. The electromagnets are arranged in a specific order and relation to one another, in a predetermined order and given a chosen strength/magnitude of repulsion that creates the engine which produces magnetic propulsion power for linear motion.

The on and off pulse signal transmission has a break between each transmission. With adjustable rates of speeds from 0 to the limits of technology. There can be from one pulse transmitted per second, up to whatever technology permits. The transmission of the on and off pulses is produced by a radio remote control signal, activating a receiver. This activates an electric current, and is only limited by engineering considerations and technology.

Referring to FIG. 1, electromagnets 21 and 23, are the strong magnetic repulsion forces, they are the repelling forces. They are limited only by engineering considerations and technology. Electromagnets 20 and 22, are the weak magnetic forces, they are repelled by electromagnets 21 and 23, respectively. Electromagnets 20 and 22 maintain a magnitude/strength equal to that of the load/craft but, they also have the capacity by means of a current control device to match electromagnets 21 and 23 strength. Electromagnets 21 and 22 are attached to the load/craft, and remain permanent and stationary. Electromagnets 20 and 23 are attached to one another by means of guide rods 30-33 with electromagnet 20 at one end of the rods and electromagnet 23 at the other end. Each rod passes through ball bearing or “magnetic bearing” 40-45 (FIG. 2) which keeps them suspended or free floating. In this arrangement electromagnets 20 and 23, all guide rods are free floating/independent by means of the bearings. This free floating arrangement is an essential element for the electromagnetic propulsion technology system to work. The interactions between electromagnets 20-23 causes movement of the load/craft. The magnets of this system 23 and 20 are free-floating, where each is independently adjustable. They can also be physically adjusted independently back and forth along the guide rods in relation to electromagnets 22 and 21 respectively, specifically 23 to 22 and 20 to 21. Magnets 22 and 21 are both fixed and stationary where they are attached to the load or craft. Magnets 23 and 20 can be moved in a back and forth direction along guide rods so as to maximize the most efficient magnetic field force.

Electromagnets 22 and 21 are energized to a desired strength/magnitude. Magnet 22 a strength equal to the weight of the load, via the rheostat/potentiometer or some other, more sophisticated control system. Electromagnet 21 has strength greater than the load/craft. Electromagnets 23 and 21 are the driving forces their strengths are generally equal at all times but can be regulated otherwise for experimental purposes. Electromagnet 23 pushes/repels along with electromagnet 21 which also pushes/repels; together they use a combined magnetic force/strength which is always greater than magnets 22 and 20 combined with the load/craft. The strengths of electromagnets 23 and 21 are adjustable, from 0 to the greatest magnitude technology permits. Magnets 22 and 20 are also adjustable, from 0 to maximum power that is available from the power source or as limited by the rheostats. Magnets 23, 21, and 22, 20 operate in harmony with the on and off pulse signal accelerated by a high-speed device computer-accelerated from 0 to the limits of technology to provide maximum speed or power.

FIG. 2 shows a perspective view of a plurality of electromagnetic propulsion movers powering an AC electric generator 80. In this embodiment three separate mover plates 90 are shown secured by a shaft 81 to the AC electric generator 80. Each mover plate 90 has four electromagnetic propulsion movers 10 secured to each mover plate 90. As the electromagnetic propulsion movers operate they exert linear motion onto the mover plate(s) 90 to create a tangential force to create rotational 82 motion onto the shaft 81 whereby allowing the AC electric generator 80 to produce voltage that to power batteries or other devices through the electrical wiring 57.

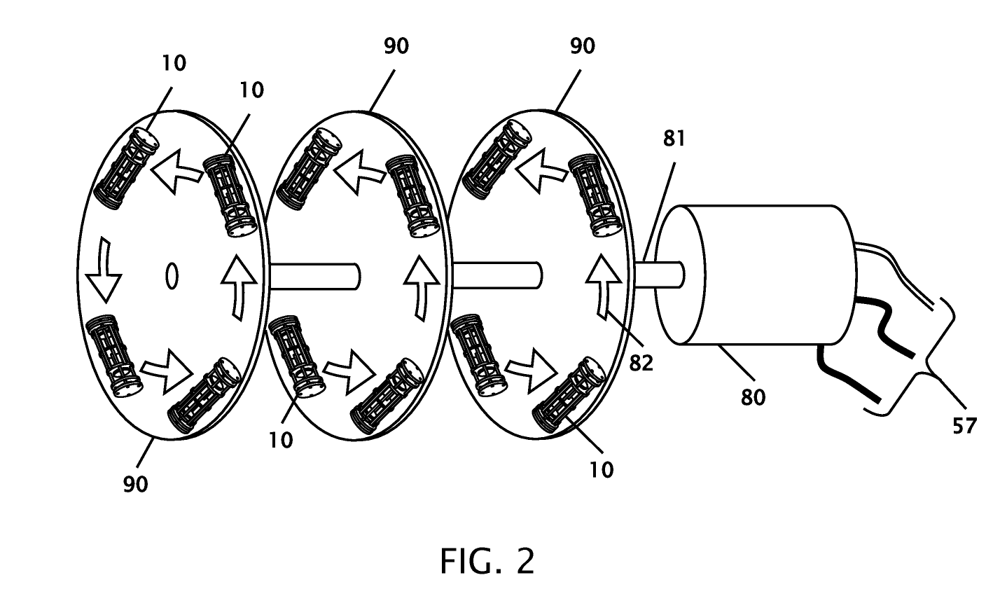

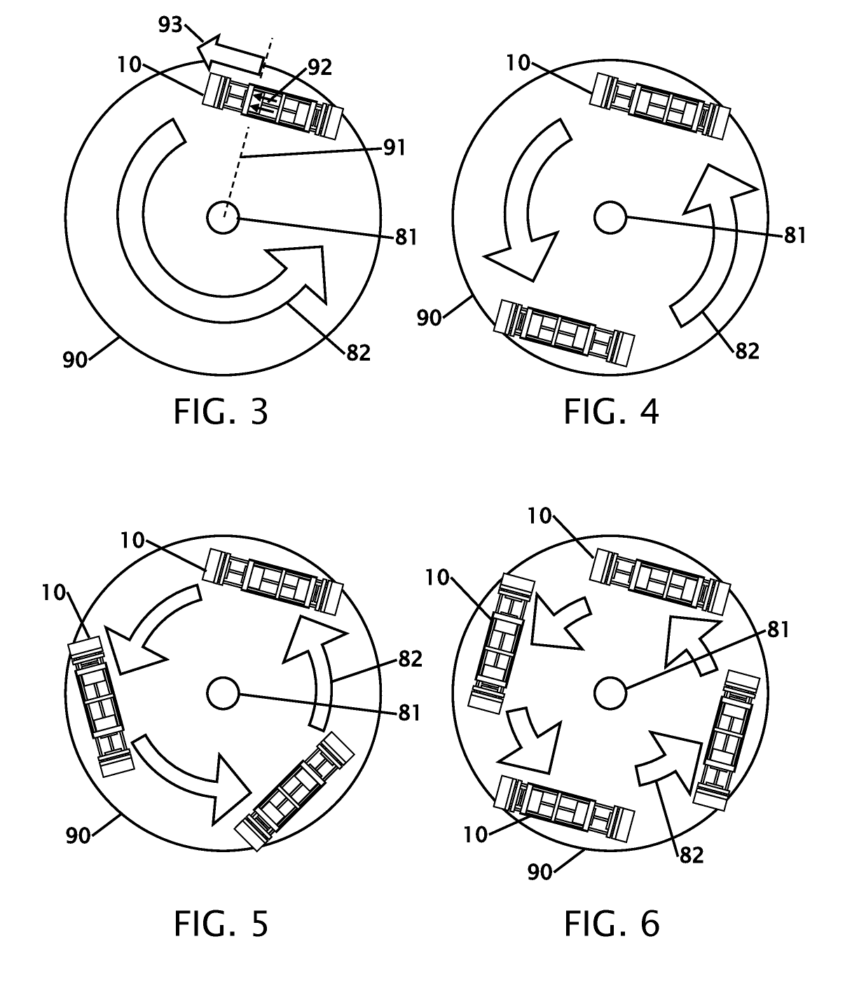

FIG. 3 shows a rotator with a single electromagnetic propulsion mover, FIG. 4 shows a rotator with two electromagnetic propulsion movers, FIG. 5 shows a rotator with three electromagnetic propulsion movers and FIG. 6 shows a rotator with four electromagnetic propulsion movers. From FIG. 3 the single electromagnetic propulsion mover 10 is oriented and aligned such that motion 92 from the electromagnetic propulsion mover 10 is placed perpendicular to a line 91 extending from the rotational axis 81. The motion 92 of the electromagnetic propulsion mover 10 imparts a tangential force 93 onto the mover plate 90 to create torque on the rotational axis 81. This torque causes the mover plate 90 to rotate 82.

It should be apparent that more than one electromagnetic propulsion mover 10 can be placed onto the mover plate 90 to increase the torque that is placed onto the shaft 81. From FIGS. 3 to 6 one to four electromagnetic propulsion movers 10 are shown. While a maximum of four electromagnetic propulsion movers are shown far more than four electromagnetic propulsion movers can be installed as well as multiple mover plates 90 can be “stacked” as shown in FIG. 2. To reduce the abrupt pulsed motion from four electromagnetic propulsion movers 10 all moving at the same time, the motion from each electromagnetic propulsion mover 10 can be pulsed in sequence or at opposing sides of the shaft 81.

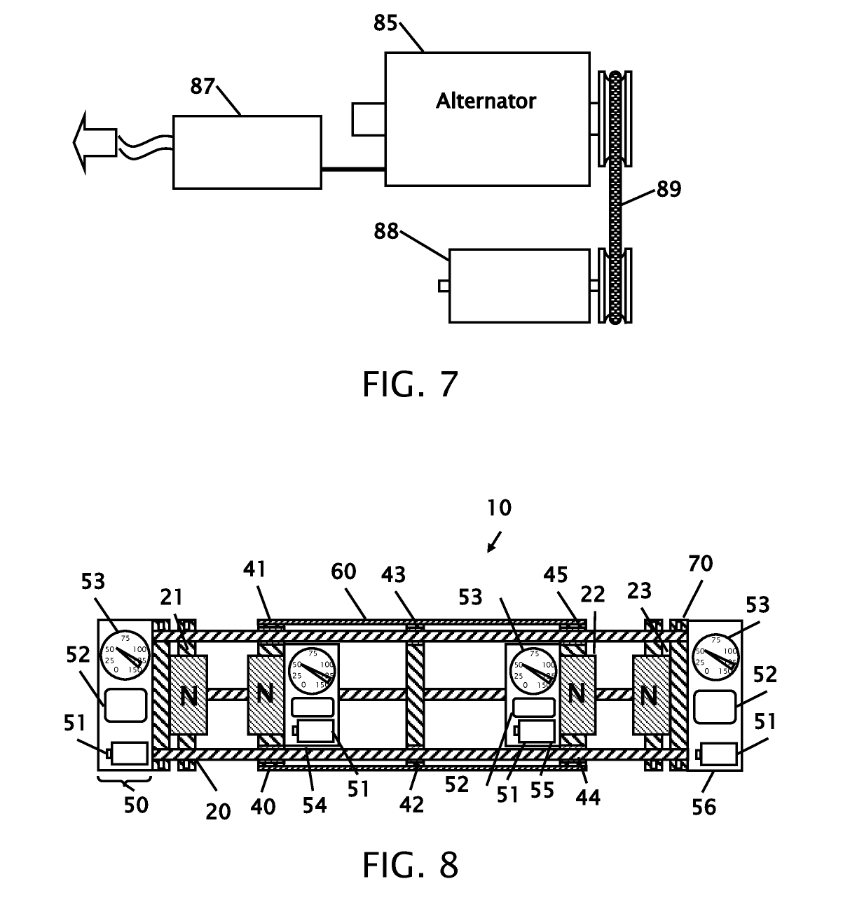

FIG. 7 shows a connection between an alternator 85 and an electric motor 88. In this embodiment the alternator 85 is connected to the electric motor 88 with a belt 89. It is further contemplated that a flywheel can be incorporated to create a smoother rotation of the system and to reduce rotational variation that can be caused by any connected electromagnetic propulsion movers (not shown in this figure). This figure also shows connection to a converter box 87 that has rectifier(s), diodes(s) and or voltage regulators that improve regulation of the voltage that is produced by the alternator 85 driven by electric motor 88. The alternator converter box 87 then supplies power movers 10 (not shown), to other systems and or to charge a battery, more so the batteries in this case. The converter box 87 includes rectifiers, diodes, and voltage regulators to convert the alternators AC voltage into DC voltage.

FIG. 8 shows a side view of the electromagnetic propulsion system. Each units coil has its own separate control unit(s) 50, 54, 55 and 56 that contains a power source 51, receiver 52 and rheostat or other similar power control device that limits the amount of power that is transmitted to the coil with each pulse. An external radio remote controlled transmitter unit transmits a stream of on and off signals that are received by receivers 52. The remote control device is operable from outside the vehicle/craft or from within the vehicle/craft. It is imperative to operate remotely, using a pulse on and off transmission transmitter, apart from the engine when activating the “pulsating “dc” “electromagnetic propulsion technology system”. The ends of the rods 30-33 go through or terminate with the end plates where they are maintained in position with a fastener 70.

The receiver 52 must complement the transmitter and there must be harmony between them in regard to the pulse transmission and pulse reception so as to energize the electromagnets simultaneously or in sequence, a chosen, predetermined order. The receiver(s) 52 activates a power source 51, which is governed by a rheostat, potentiometer 53 or similar power control/limiter. More sophisticated electronic control device can be connected to the electromagnets/superconducting magnets to energize them in a desired way or to a desired magnetic field intensity/gauss, magnitude of the on and off pulses.

This system eliminates the need for power sources such as gas, coal, oil, hydroelectric, wind, nuclear, steam and others because it replaced the turbines. The AC electricity generate by this method will be fed back to the system just as the AC is fed to the general public as it power source. Just as a trolley car feeds off an electrical source, so can the electromagnetic propulsion system with the application of rectifiers, diodes, voltage regulators and batteries.

Thus, specific embodiments of an electromagnetic propulsion system have been disclosed. It should be apparent, however, to those skilled in the art that many more modifications besides those described are possible without departing from the inventive concepts herein. The inventive subject matter, therefore, is not to be restricted except in the spirit of the appended claims.

What is claimed is:

1. A electromagnetic propulsion system comprising:
a rotator connected to an essentially central shaft;
said rotator having at least one electromagnetic propulsion mover placed essentially planar with said rotator and placed at a distance from said central shaft such that temporal linear motion created by said electromagnetic propulsion mover imparts rotational motion to said rotator that turns said essentially central shaft;
said electromagnetic propulsion mover creates said temporal linear motion by repelling electromagnets within said electromagnetic propulsion mover.

2. The electromagnetic propulsion system according to claim 1 wherein said rotator has at least two electromagnetic propulsion movers.

3. The electromagnetic propulsion system according to claim 2 wherein all of said electromagnetic propulsion movers impart said temporal linear motion at the same time.

4. The electromagnetic propulsion system according to claim 2 wherein said each of said electromagnetic propulsion movers impart said temporal linear motion in essentially equally spaced time intervals.

5. The electromagnetic propulsion system according to claim 1 wherein said central shaft is connected to a power generator.

6. The electromagnetic propulsion system according to claim 1 wherein said central shaft is connected to a vehicle.

7. The electromagnetic propulsion system according to claim 1 wherein said rotator further includes a connecting means for securing a tire.

8. The electromagnetic propulsion system according to claim 1 that further includes a power controller that varies the amount of power that is applied to at least one electromagnetic propulsion mover.

9. The electromagnetic propulsion system according to claim 1 that further includes a power controller that varies the amount of time between said application of temporal linear motion.

10. The electromagnetic propulsion system according to claim 1 wherein a plurality of said rotators are connected onto said essentially central shaft wherein each of said rotators has at least one electromagnetic propulsion mover.

11. The electromagnetic propulsion system according to claim 1 wherein each of said electromagnetic propulsion movers has at least one battery.

12. The electromagnetic propulsion system according to claim 1 wherein each of said electromagnetic propulsion movers has a receiver that receives.

13. The electromagnetic propulsion system according to claim 12 wherein said receiver receives a wireless command signal to operate said electromagnetic propulsion mover.

14. The electromagnetic propulsion system according to claim 1 wherein said electromagnetic propulsion movers include wound coils.

15. The electromagnetic propulsion system according to claim 11 wherein said electromagnetic propulsion movers recharge said battery.

16. The electromagnetic propulsion system according to claim 5 wherein said generator generates AC voltage.

17. The electromagnetic propulsion system according to claim 5 wherein said generator generates AC voltage.

18. The electromagnetic propulsion system according to claim 1 wherein said electromagnetic propulsion movers are used to change the direction of travel of a vehicle.

19. The electromagnetic propulsion system according to claim 1 wherein said electromagnetic propulsion movers can start rotation of said rotor when said rotor is at rest.

20. The electromagnetic propulsion system according to claim 1 wherein said electromagnetic propulsion movers provide propulsion for a land vehicle.

21. The electromagnetic propulsion system according to claim 1 wherein said electromagnetic propulsion movers provide propulsion for a water or air vehicle.
